(19) United States
(12) Patent Application Publication
(10) Pub. No.: US 2002/0195463 A1
(43) Pub. Date: Dec. 26, 2002

(54) Control mechanism for trace quantity of liquid

(76) Inventors: Minoru Seki, Tokyo (JP); Ryusuke Aoyama, Nagareyama-shi (JP); Jong Wook Hong, Pasadena, CA (US); Teruo Fujii, Tokyo (JP); Isao Endo, Tokyo (JP)

Correspondence Address: BIRCH STEWART KOLASCH & BIRCH, PO BOX 747, FALLS CHURCH, VA, 22040-0747, US

(21) Appl. No.: 10/157,075

(22) Filed: May 30, 2002

(30) Foreign Application Priority Data
May 31, 2001 (JP) 2001-163740

(51) Int. Cl. B67D 5/60

(52) U.S. Cl. 222/134

(57) ABSTRACT

In order to be capable of handling quantitatively a liquid in a simple structure by only easy operations, a control mechanism comprises a first flow channel and a second flow channel each extending along a predetermined direction; and a third flow channel having a thinner thickness than that of the first flow channel and that of the second flow channel; the above-described third flow channel being opened on flow channel walls of the first flow channel and the second flow channel, respectively, whereby the third flow channel links the first flow channel to the second flow channel; a liquid introduced into the first flow channel being pulled in the third flow channel due to a capillary phenomenon through an opening of the third flow channel opened on the flow channel wall of the first flow channel, and then, the liquid remained in the first flow channel being removed to prepare a droplet having a volume corresponding to a capacity of the third flow channel.

### BACKGROUND OF THE INVENTION

1. Field of The Invention

The present invention relates to a control mechanism for a trace quantity of liquid, and more particularly to a control mechanism for a trace quantity of liquid used suitably in the case where an analysis or a chemical reaction is conducted by utilizing a variety of samples.

2. Description of The Related Art

Heretofore, various analyzing units in accordance with electrophoresis, chromatography, and the like have been known. In these units, when a liquid sample can be quantitatively handled, correctly analyzed results are obtained.

In this connection, a variety of manners for handling quantitatively a liquid sample and the like in various units applied to electrophoresis, chromatography or the like has been proposed. However, any of these manners has involved such a problem that an amount of sample more than that required actually for analysis becomes necessary, so that a dead volume of such sample cannot be reduced.

On one hand, a power supply or the like becomes necessary in a manner wherein voltage is to be applied for handling quantitatively liquid, so that there has been such a problem that space saving and reduction in cost for the whole analyzing unit cannot be realized.

Furthermore, there is a case where a microchip made of a minute chip is used for a chemical reaction, an analysis and the like wherein a trace quantity of a liquid sample or the like is applied. In case of employing also such microchip, when a liquid sample to be applied can be quantitatively handled, correct results are achieved. In this case, however, a variety of complicated constitutions is required for handling quantitatively the liquid, so that there has been such a problem that operations for handling the constitutions as described above become troublesome.

### OBJECT AND SUMMARY OF THE INVENTION

The present invention has been made in view of the various problems as described above involved in the prior art.

An object of the present invention is to provide a control mechanism for a trace quantity of liquid by which a liquid can be quantitatively handled based on a simple structure by only easy operations.

A further object of the present invention is to provide a control mechanism for a trace quantity of liquid by which a dead volume of sample can be reduced in a variety of unit wherein liquid must be handled quantitatively, besides, space saving and reduction in cost of the whole various units can be achieved.

In order to attain the above-described objects, surface tension of liquid is aimed, and a capillary phenomenon, which derives from a liquid flowing through a flow channel, is utilized in the present invention.

FIGS. 1(a) and 1(b) are conceptual views each explaining for a principle of the present invention wherein there is a structure involving three flow channels A, B, and C, and in this case when the thin flow channel C is bridged across the two thick flow channels A and B, in other words, when the two thick flow channels A and B are linked by means of the thin flow channel C, a capillary attraction force in an end surface of liquid in the thin flow channel C is stronger than that of the liquid in the thick flow channels A and B. For this reason, the liquid in the thick flow channel A or B flows into the thin flow channel C, so that a positive capillary phenomenon appears.

More specifically, when a liquid 100 (see a meshed region shown in each of FIGS. 1(a) and 1(b)) is introduced into the flow channel A in the two thick flow channels A and B, the liquid 100 is brought in the thin flow channel C by means of a stronger capillary attraction force from an opening c1, which is opened on a flow channel wall aa of the flow channel A, in the thin flow channel C (see FIG. 1(a)).

In this case, the liquid 100 that has reached the other flow channel end opposite to an end of the thin flow channel C, i.e., an opening c2 of the thin flow channel C, which is opened on a flow channel wall bb of the thick flow channel B is under restraint by a stronger capillary attraction force in the thin flow channel C, so that the liquid does not flow into the thick flow channel B.

Then, the liquid 100 remained in the thick flow channel A is transferred to a lower pressure side in the thick flow channel A by means of, for example, a suitable pressure difference produced between opposite ends of the thick flow channel A, whereby the liquid 100 is removed from the thick flow channel A (see FIG. 1(b)).

In such case, the liquid 100 in the thin flow channel C is retained therein by means of a stronger capillary attraction force in the thin flow channel C, but it does not return into the thick flow channel A.

Thus, end surfaces 100a and 100b corresponding to opposite ends of the liquid 100 in the thin flow channel C are positioned at both the openings c1 and c2 in the thin flow channel C, so that the liquid 100 remains in only the thin flow channel C among the three flow channels A, B, and C, whereby it becomes possible to define a droplet having a volume corresponding to a capacity of the thin flow channel C.

Accordingly, a control mechanism for a trace quantity of liquid of the present invention comprises a first flow channel and a second flow channel each extending along a predetermined direction; and a third flow channel having a thinner thickness than that of the first flow channel and that of the second flow channel; the third flow channel being opened on flow channel walls of the first flow channel and the second flow channel, respectively, whereby the third flow channel links the first flow channel to the second flow channel; a liquid introduced into the first flow channel being pulled in the third flow channel by means of a capillary phenomenon through an opening of the third flow channel opened on the flow channel wall of the first flow channel, and then, the liquid remained in the first flow channel being removed to prepare a droplet having a volume corresponding to a capacity of the third flow channel.

Thus, according to the present invention, a liquid introduced into the first flow channel is pulled in the third flow channel by means of a capillary phenomenon to prepare a droplet having a volume corresponding to a capacity of the third flow channel, so that liquid can be handled quantitatively in accordance with a simple structure by only easy operations, besides a dead volume of sample can be reduced, and space saving and reduction in cost of the whole unit can be realized.

Furthermore, a control mechanism for a trace quantity of liquid according to the present invention comprises at least two systems; any of the systems being composed of a first flow channel as well as a second flow channel each extending along a predetermined direction, and a third flow channel having a thinner thickness than that of the first flow channel and that of the second flow channel, the third flow channel being opened on flow channel walls of the first flow channel and the second flow channel, respectively, whereby the third flow channel links the first flow channel to the second flow channel, a liquid introduced into the first flow channel being pulled in the third flow channel by means of a capillary phenomenon through an opening of the third flow channel opened on the flow channel wall of the first flow channel, and then, the liquid remained in the first flow channel being removed to prepare a droplet having a volume corresponding to a capacity of the third flow channel; and the two systems having either of the first channel and the second channel in common.

Hence, according to the present invention, two systems have either of the first flow channel and the second flow channel in common, so that when different types of droplets are prepared quantitatively in the two systems having, for example, the second flow channel in common, coalescent/analytical reaction can be made with respect to plural types of droplets prepared in the second flow channel being common in these two systems.

Moreover, in a control mechanism for a trace quantity of liquid according to the present invention, a condition of relationship: “S₁≧S₃>S₂≧S₄” where a sectional area corresponding substantially to the opening of the third flow channel in the first flow channel is S₁, a sectional area corresponding substantially to the opening of the third flow channel in the second flow channel is S₂, a sectional area of the opening of the third flow channel is S₃, and a sectional area of the opening of the third flow channel is S₄ may be satisfied.

According to the above-described arrangement, a droplet prepared quantitatively in the third flow channel can be easily run off from an opening of the third flow channel opened on a flow channel wall of the second flow channel thereto.

Further, in a control mechanism for a trace quantity of liquid according to the present invention, a plurality of the third flow channels may be defined.

Thus, according to the present invention, droplets having volumes corresponding to capacities of the plurality of the third flow channels can be prepared quantitatively and parallelly.

Still further, a control mechanism for a trace quantity of liquid according to the present invention may comprise further a means for running off a droplet prepared and having a volume corresponding to a capacity of the third flow channel therefrom to the second flow channel through the opening of the third flow channel opened on a flow channel wall of the second flow channel.

Thus, according to the present invention, the droplet prepared quantitatively in the third flow channel can be more positively run off from the opening of the third flow channel opened on the flow channel wall of the second flow channel thereto.

Yet further, in control mechanism for a trace quantity of liquid according to the present invention, the first flow channel, the second flow channel, and the third flow channel are defined on a microchip.

Hence, according to the present invention, a droplet having a trace quantity of liquid can be prepared quantitatively in a simple structure by only easy operations, besides much more dead volume of a sample as well as space saving and reduction in cost of the whole unit can be realized.

In addition, in a control mechanism for a trace quantity of liquid according to the present invention, flow channel walls of the first flow channel, the second flow channel, and the third flow channel may be made to be hydrophilic.

Besides, in a control mechanism for a trace quantity of liquid according to the present invention, the capacity of the third flow channel may have a nl (nanoliter) ordered dimension.

As a result, according to the present invention, droplets each having a nl ordered volume of a trace quantity of liquid can be prepared quantitatively in a simple structure by only easy operations.

### BRIEF DESCRIPTION OF THE DRAWING

The present invention will become more fully understood from the detailed description given hereinafter and the accompanying drawings which are given by way of illustration only, and thus are not limitative of the present invention, and wherein:

FIGS. 1(a) and 1(b) are conceptual views each for explaining a principle of the present invention;

FIGS. 2(a) and 2(b) are views each showing a microchip embodied in a first manner of a control mechanism for a trace quantity of liquid according to the present invention wherein FIG. 2(a) is a view in the direction of the arrow A in FIG. 2(b), and FIG. 2(b) is a sectional view taken along the line B-B of FIG. 2(a);

FIG. 3 is an explanatory view showing principally a first channel, a second channel, and a third channel that constitute a micro channel by enlarging a part of FIG. 2(a);

FIGS. 4(a), 4(b), 4(c), 4(d), 4(e), 4(f), and 4(g) are outlined explanatory views each showing a fabrication process of a microchip involving a control mechanism for a trace quantity of liquid according to the present invention;

FIGS. 5(a), 5(b), and 5(c) outlined explanatory views each for explaining preparation of a droplet in the microchip involving a control mechanism for a trace quantity of liquid according to the present invention;

FIGS. 6(a) and 6(b) are outlined explanatory views each for explaining outflow of the droplet prepared in the microchip involving the control mechanism for a trace quantity of liquid according to the present invention;

FIGS. 7(a) and 7(b) are explanatory views each showing a case wherein a plurality of third channels are defined in a microchip embodied in the first manner of a control mechanism for a trace quantity of liquid according to the present invention;

FIGS. 8(a) and 8(b) are views each showing a microchip embodied in a second manner of a control mechanism for a trace quantity of liquid according to the present invention wherein FIG. 8(b) is an enlarged view showing an essential part of FIG. 8(a);

FIG. 9 is an explanatory view showing a constitution of an experimental system wherein a microchip embodied in the second manner of a control mechanism for a trace quantity of liquid according to the present invention is applied;

FIGS. 10(a), 10(b), 10(c) 10(d), 10(e), 10(f), and 10(g) are outlined explanatory views for each explaining an example of chemical reaction wherein a microchip embodied in the second manner of a control mechanism for a trace quantity of liquid according to the present invention is applied;

FIGS. 11(a), 11(b), and 11(c) are explanatory views each showing another example of a microchip embodied in the second manner of a control mechanism for a trace quantity of liquid according to the present invention;

FIGS. 12(a) and 12(b) are explanatory views each showing a further example of a microchip embodied in the second manner of a control mechanism for a trace quantity of liquid according to the present invention;

FIG. 13 is an explanatory view showing a still further example of a microchip embodied in the second manner of a control mechanism for a trace quantity of liquid according to the present invention;

FIG. 14 is an explanatory view showing an yet example of a microchip involving a control mechanism for a trace quantity of liquid according to the present invention; and

FIG. 15 is an explanatory view showing a yet further example of a microchip involving a control mechanism for a trace quantity of liquid according to the present invention.

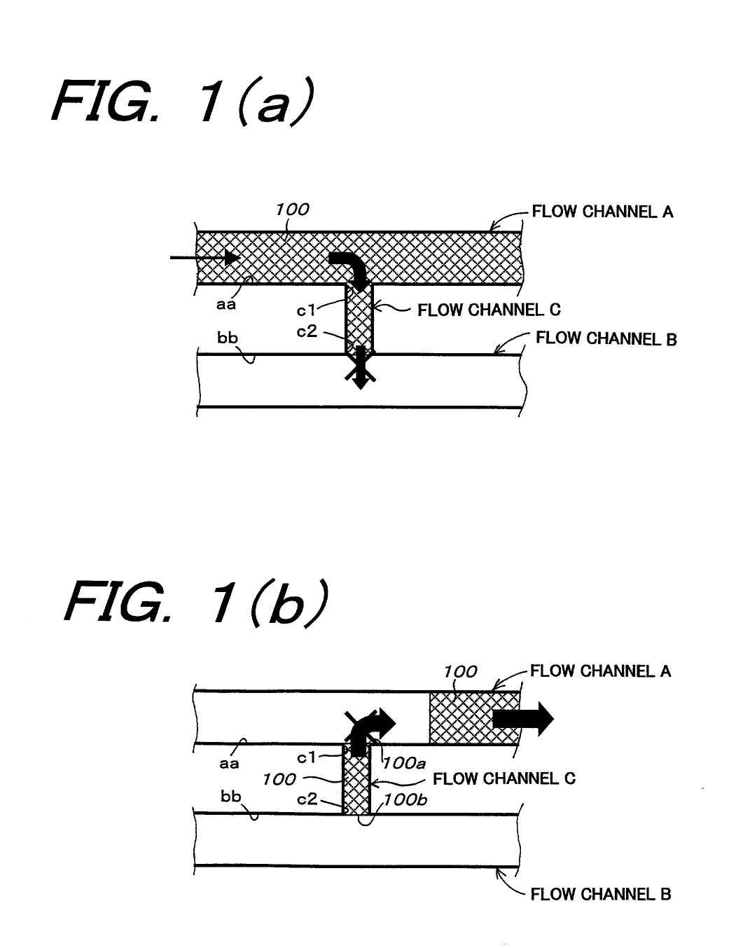

### DETAILED DESCRIPTION OF THE PREFERRED EMBODIMENTS

In the following, embodiments of a control mechanism for a trace quantity of liquid according to the present invention will be described in detail by referring to the accompanying drawings.

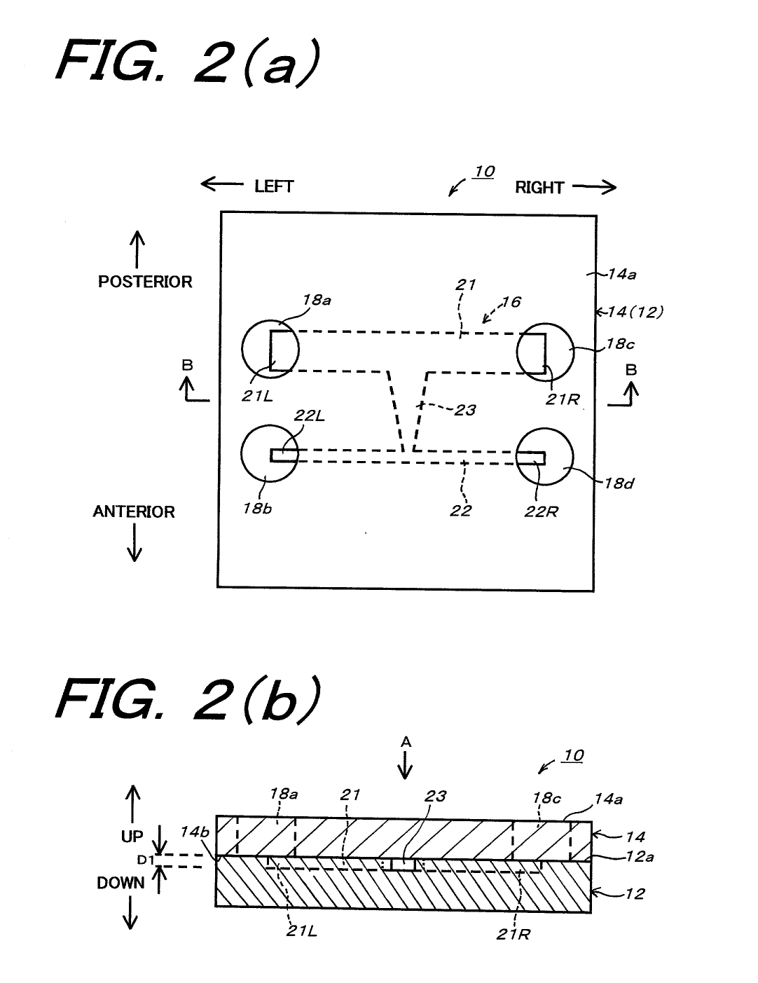

FIGS. 2(a) and 2(b) are views each showing a microchip embodied in the first manner of a control mechanism for a trace quantity of liquid according to the present invention wherein FIG. 2(a) is a view in the direction of the arrow A in FIG. 2(b), and FIG. 2(b) is a sectional view taken along the line B-B of FIG. 2(a).

In these figures, the microchip 10 is composed of a flat plate-like base plate 12 made of a high molecular (polymeric) material such as PDMS (polydimethyl siloxane) and a flat plate-like surface plate 14 made of PMMA (polymethyl methacrylate) disposed on the top 12a of the base plate 12.

A microchannel 16 being a so-called I-shaped linear-type flow channel is defined on the top 12a of the base plate 12.

The microchannel 16 is composed of a first channel 21 and a second channel 22 extending laterally in parallel to each other in the top 12a of the base plate 12 and a third channel 23 that links the first channel 21 to the second channel 22.

The first channel 21, the second channel 22, and the third channel 23 constituting the microchannel 16 defined on the top 12a of the base plate 12 as described above is sealed with the surface plate 14.

Furthermore, four ports, i.e., a first port 18a, a second port 18b, a third port 18c, and a fourth port 18d each for charging or discharging a variety of liquids such as a sample are defined on the surface plate 14 as openings so as to run through it from an upper surface 14a to a lower surface 14b of the surface plate 14.

The first port 18a, the second port 18b, the third port 18c, and the fourth port 18d as well as the first channel 21 and the second channel 22 are dimensioned and positioned in such that the left end 21L of the first channel 21 is positioned in a part of the first port 18a, the left end 22L of the second channel 22 is positioned in a part of the second port 18b, the right end 21R of the first channel 21 is positioned in a part of the third port 18c, and the right end 22R of the second channel 22 is positioned in a part of the fourth port 18d. As a result, the first port 18a communicates with the left end 21L of the first channel 21, the second port 18b communicates with the left end 22L of the second channel 22, the third port 18c communicates with the right end 21R of the first channel 21, and the fourth port 18d communicates with the right end 22R of the second channel 22, respectively.

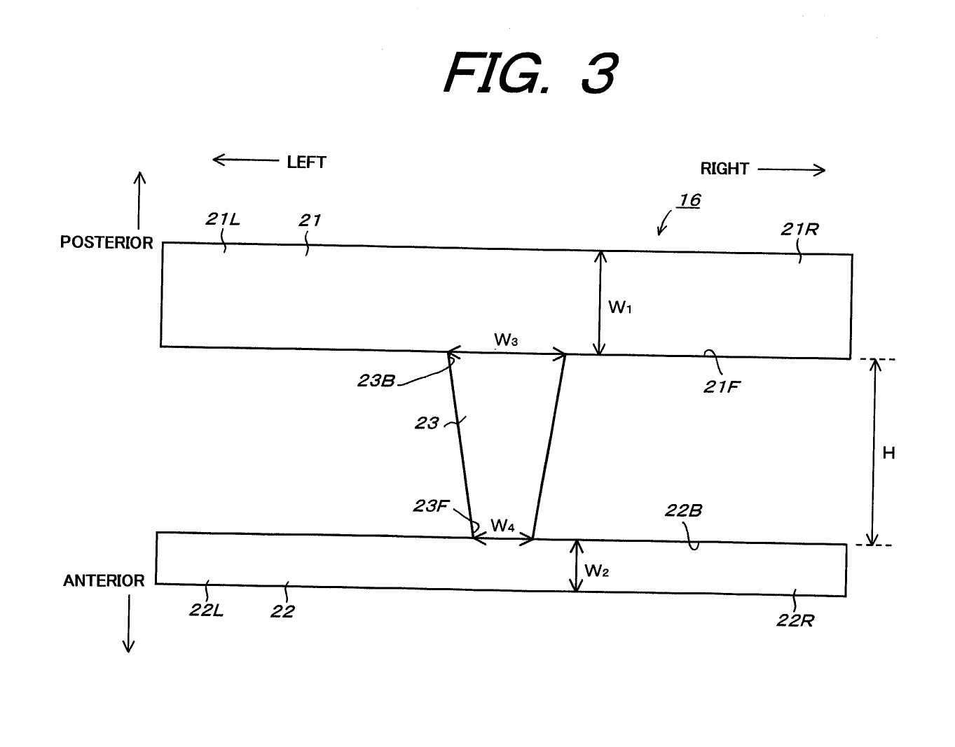

FIG. 3 is an explanatory view showing an enlarged part of FIG. 2(a) wherein the first channel 21, the second channel 22, and the third channel 23 constituting the microchannel 16 are illustrated.

In the figure, the third channel 23 extending along an anteroposterior direction is disposed in a substantially central region of the first channel 21 and the second channel 22 extending laterally on the top 12a of the base plate 12.

In this arrangement, the third channel 23 is opened at an opening 23B on a flow channel wall 21F on an anterior side of the first channel 21, while the third channel 23 is opened at an opening 23F on a flow channel wall 22B on a posterior side of the second channel 22, and the first channel is linked to the second channel through the third channel 23 in a communicating manner.

In this case, all the first channel 21, the second channel 22, and the third channel 23 are formed on the same level, each of these channels has the same depth D1 (see FIG. 2(b)), and each cross section of them is a rectangular profile.

Moreover, dimensions of a width W₁ corresponding substantially to the opening 23B of the third channel 23 in the first channel 21, a width W₂ corresponding substantially to the opening 23F of the third channel 23 in the second channel 22, a width W₃ of the opening 23B of the third channel 23, and a width W₄ of the opening 23F of the third channel 23 are dimensioned to have a relationship satisfying the following numerical formula 1.

W₁≧W₃>W₂≧W₄ Numerical Formula 1

Accordingly, all the first channel 21, the second channel 22, and the third channel 23 have respective rectangular profiles in their cross sections, each of them has the same depth D1, and they satisfy the above numerical formula 1 as described above. Hence, a sectional area S₁ corresponding substantially to the opening 23B of the third channel 23 in the first channel 21, a sectional area S₂ corresponding substantially to the opening 23F of the third channel 23 in the second channel 22, a sectional area S₃ of the opening 23B of the third channel 23, and a sectional area S₄ of the opening 23F of the third channel 23 satisfy the following numerical formula 2.

S₁≧S₃>S₂≧S₄ Numerical Formula 2

It is to be noted that all the inner walls of the first channel 21, the second channel 22, and the third channel 23 constituting the microchannel 16 as well as all the wall surfaces of the first port 18a, the second port 18b, and the fourth port 18d are made to be hydrophilic.

Each depth of the first channel 21, the second channel 22, and the third channel 23 is not limited to the same depth D1, but they may have separate depths different from one another. Namely, they may be arbitrary depths according to need, for instance, it is possible to select an arbitrary value ranging from 1 μm to 8000 μm for these depths, respectively.

Furthermore, the width W₁ of the first channel 21, the width W₂ of the second channel 22, width W₃ of the opening 23B in the third channel 23, and the width W₄ of the opening 23F in the third channel 23 are not specifically limited, but they may be dimensioned arbitrarily according to need, for example, it is possible to select an arbitrary value ranging from 1 μm to 8000 μm for these widths, respectively.

Moreover, the overall lengths of the first channel 21 and the second channel 22 in their lateral directions as well as the overall length of the third channel 23 in its anteroposterior direction are not specifically limited, but they may be dimensioned arbitrarily according to need, for example, it is possible to select an arbitrary value ranging from 1 μm to 8000 μm for these lengths, respectively.

In brief, there is no specific limitation as to dimensions in the first channel 21, the second channel 22, and the third channel 23 constituting the microchannel 16, but suitable values may be taken for obtaining a desired volume in the third channel 23 (in other words, dependent upon a volume of a droplet to be prepared) so far as all the above-described sectional areas satisfy the numerical formula 2.

More specifically, for example, a volume of five (5) nl (nanoliter) in the third channel 23 can be obtained from such condition that a depth D1 is 50 μm, the width W₃ of the opening 23B in the third channel 23 is 100 μm, the width W₄ of the opening 23F in the third channel 23 is 50 μm, and a distance H defined between the opening 23B and the opening 23F (see FIG. 3) is 1000 μm.

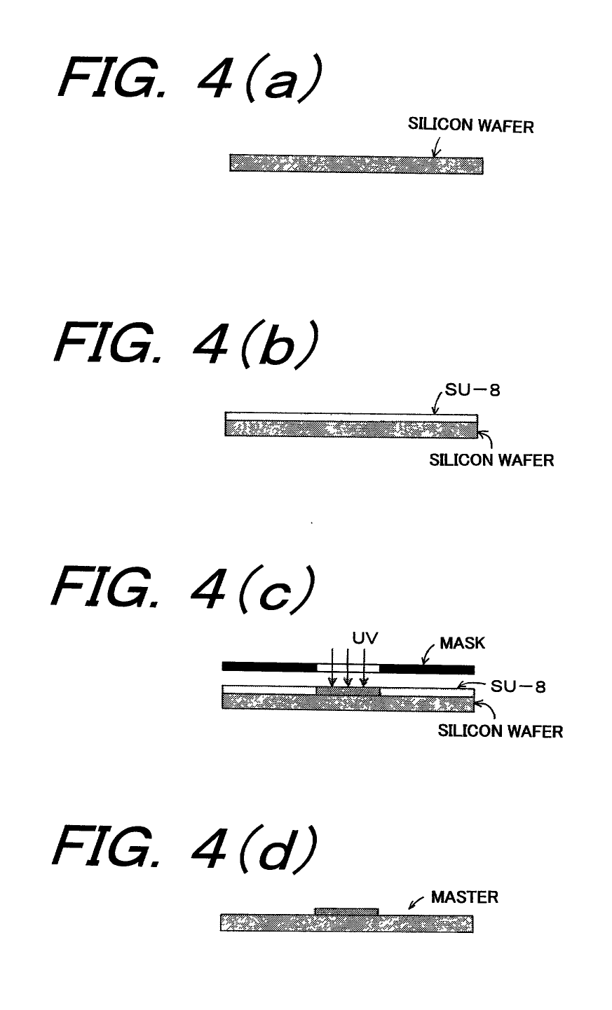

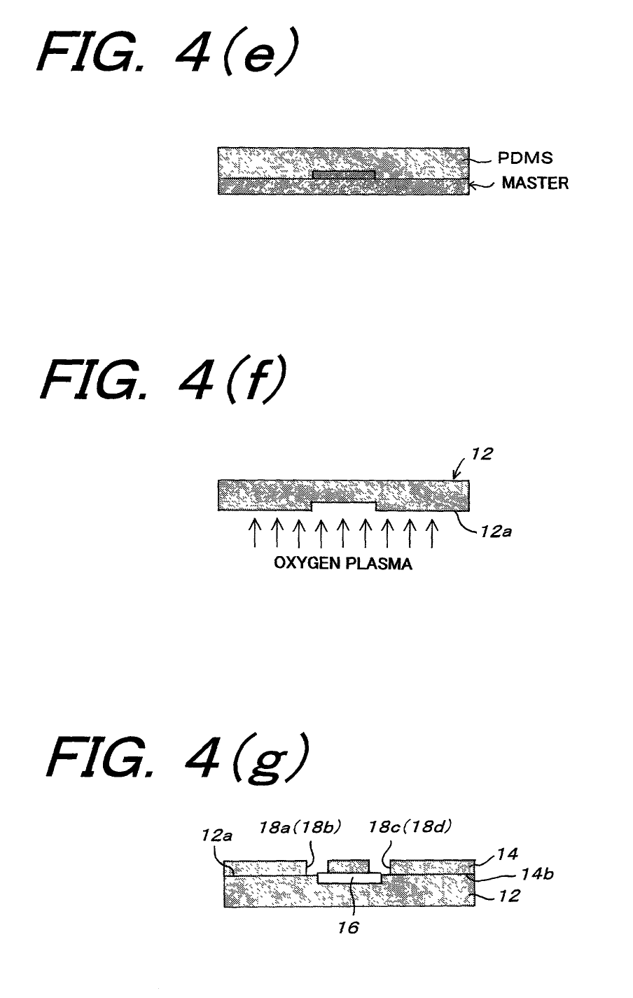

The above-described microchip 10 can be fabricated in accordance with, for example, a fabrication process, which is described by referring to FIGS. 4(a) through 4(g). Before the fabrication process, first, a pattern of layout for the first channel 21, the second channel 22, and the third channel 23, i.e., the microchannel 16 in the microchip 10 has been printed on a clear film having a high resolution of, for example, 4064 dpi in order to utilize a mask for photolithography.

FIGS. 4(a) through 4(g) are outlined views each showing a fabrication process of the microchip 10 wherein there are two steps of preparing a master (see FIGS. 4(a) through 4(d)) and preparing a PDMS chip (see FIGS. 4(e) through 4(g)).

In the following, a process for fabricating the microchip 10 involving the above-described base plate 12 made from PDMS will be described in detail.

First, a silicon (Si) wafer is dried in an oven (see FIG. 4(a)), the resulting silicon wafer is spin-coated with a negative photoresist SU-8 at 500 rpm for ten seconds, then, at 1500 rpm for ten seconds, and thereafter the silicon wafer thus coated is kept warm in the oven at 90° C. for thirty minutes (see FIG. 4(b)).

Then, a layout pattern in the microchip 10, which has been printed on a mask, is transferred on the SU-8 coated silicon wafer by the use of a mask aligner (for example, PEM-80; Union Optical Co., Tokyo, Japan may be used as a mask aligner) in accordance with a manner of phtolithography, and the resulting silicon wafer is placed in 1-methoxy-2-propylacetic acid for twenty hours to develop the same (see FIG. 4(c) and FIG. 4(d)).

The master thus fabricated has a convex structure used as a matrix of the microchannel 16 in the base plate 12. The master is washed with isopropyl alcohol, and succeedingly with distilled water.

Before pouring a PDMS prepolymer, the master is treated with fluorocarbon by the use of an RIE (Reactive Ion Etching) system. This fluorocarbon treatment is useful for release of a PDMS replica after a templating process.

Thereafter, the PDMS prepolymer is mixed with a curing agent (for example, Sylgard 184; Dow Corning Co., MI may be used as a curing agent) at a ratio of 10:1, the mixture is sufficiently agitated, and then, the resulting mixture is deaerated under vacuum for only fifteen minutes to prepare a prepolymer mixed solution. The prepolymer mixed solution thus prepared is poured on the master, and the prepolymer is cured at 65° C. for one hour, then at 95° C. for fifteen minutes (see FIG. 4(e)).

After the above-described curing, when the PDMS replica is peeled off from the master, the PDMS base plate 12 can be obtained (see FIG. 4(f)). Further, a side of the top 12a in the base plate 12 is oxidized with oxygen plasma by the use of the RIE system to apply hydrophilic treatment thereto.

On the other hand, the first port 18a, the second port 18b, the third port 18c, and the fourth port 18d are bored on the flat plate-like surface plate 14. Further, a side of the bottom 14b in the surface plate 14 as well as the first port 18a, the second port 18b, the third port 18c, and the fourth port 18d are oxidized also with oxygen plasma by the use of the RIE system to apply hydrophilic treatment thereto.

The PDMS base plate 12 is laid over and placed on the surface plate 14 in such that the top 12a of the base plate 12 is in contact with the bottom 14b of the surface plate 14, whereby the first channel 21, the second channel 22, and the third channel 23 constituting the microchannel 16 are sealed (see FIG. 4(g)).

It is to be noted that a hydrophilic treatment to be applied to the top 12a of the base plate 12 and the bottom 14b of the surface plate 14 as well as the first port 18a, the second port 18b, the third port 18c, and the fourth port 18d is not limited to a manner for oxidation with oxygen plasma as described above, the other manners may properly be utilized.

Moreover, when such hydrophilic treatment is applied to the whole surfaces of the top 12a of the base plate 12 and the bottom 14b of the surface plate 14 as well as the whole surfaces of the first port 18a, the second port 18b, the third port 18c, and the fourth port 18d, all the inner walls of the first channel 21, the second channel 22, and the third channel 23 as well as the wall surfaces of the first port 18a, the second port 18b, the third port 18c, and the fourth port 18d may make to be hydrophilic. Thus, the hydrophilic treatment can be achieved in accordance with an easy process unlike a manner wherein such hydrophilic treatment is applied to only a specified range.

In the first embodiment, such expression that the first channel 21, the second channel 22, and the third channel 23 constituting the microchannel 16 are sealed does not mean to the effect that the first channel 21, the second channel 22, and the third channel 23 constituting the microchannel 16 are hermetically sealed, but it means that the first port 18a communicates with the left end 21L of the first channel 21, the second port 18b communicates with the left end 22L of the second channel 22, the third port 18c communicates with the right end 21R of the first channel 21, and the fourth port 18d communicates with the right end 22R of the second channel 22.

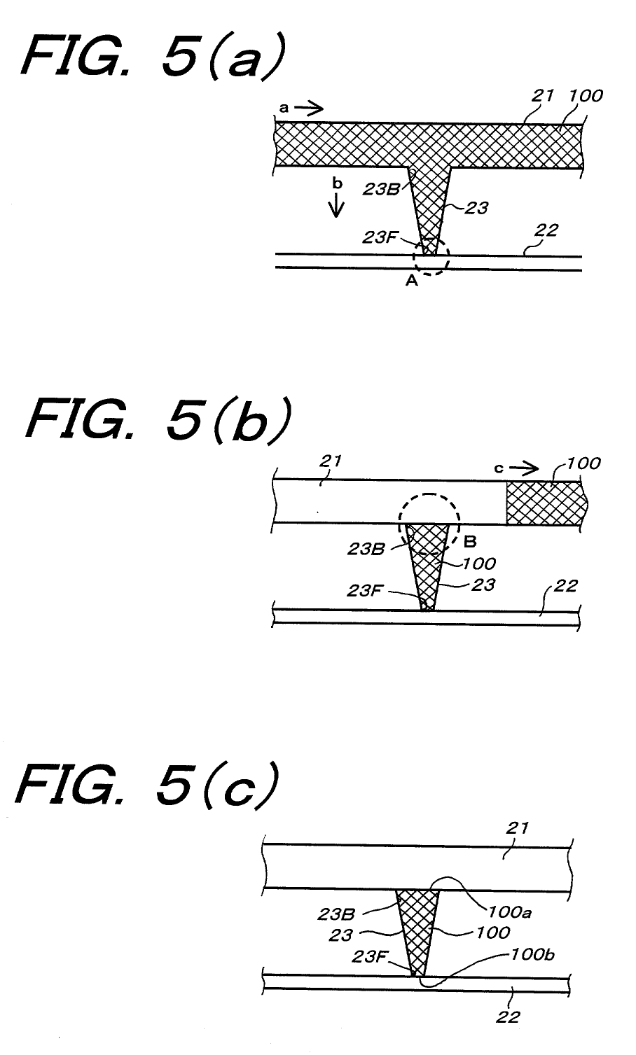

In the above-described constitution, preparation for a droplet by the use of the above-described microchip 10 will be described by referring to FIGS. 5(a), 5(b), and 5(c).

FIGS. 5(a) through 5(c) are outlined explanatory views for each explaining preparation of a droplet in the microchip 10 involving a control mechanism for a trace quantity of liquid according to the present invention.

First, when a liquid 100 (see a halftone dot meshed region in FIG. 5(a)) is introduced from the first port 18a, the liquid 100 introduced is pulled from the left end 21L of the first channel 21 communicating with the first port 18a into the first channel 21 by means of a capillary phenomenon (see an arrow a in FIG. 5(a)).

Since there is the following relationship:

Sectional Area S₁≧Sectional Area S₃,

the liquid 100 thus introduced into the first channel 21 is pulled from the opening 23B into the third channel 23 by means of a stronger capillary attraction force through the opening 23B of the third channel 23.

Moreover, since there is the following relationship:

Sectional Area S₃>Sectional Area S₄,

the liquid 100 pulled in the third channel 23 is further pulled in a direction directed from the opening 23B to the opening 23F inside the third channel (see an arrow b in FIG. 5(a)).

However, since there is the following relationship:

Sectional Area S₂≧Sectional Area S₄,

the liquid 100 reached the opening 23F of the third channel 23 is captured by a stronger capillary attraction force in the third channel 23, so that the liquid 100 does not enter inside the second channel 22 (see a circled area A with a dashed line).

Then, the liquid 100 remained in the first channel 21 is transferred to a side being under a lower pressure by, for example, generating an appropriate pressure difference defined between the left end 21L and the right end 21R in the first channel 21, whereby the liquid 100 remained is removed from the inside of the first channel 21 (see an arrow c in FIG. 5(b)).

In this case, since there is the following relationship:

Sectional Area S₁>Sectional Area S₄,

the liquid 100 in the third channel 23 retained inside the third channel 23 by means of a stronger capillary attraction force in the third channel 23, so that the liquid 100 does never return to and enter the first channel 21 (see a circled area B with a dashed line in FIG. 5(b)).

As a result, both the end surfaces of the liquid 100 in the third channel 23, i.e., an end surface 100a and an end surface 100b of the liquid 100 are positioned on the opening 23B and the opening 23F in the third channel 23, respectively, so that the liquid 100 remains in only the third channel 23, whereby a droplet having a volume corresponding to a capacity of the third channel 23 is prepared (see FIG. 5(c)).

More specifically, in the case where a capacity of the third channel 23 in the microchip 10 has been set to be five nl in accordance with a manner as described above, ten mM (millimole) of aqueous aniline blue solution are used as a sample liquid 100, and one μl (microliter) of which is dropped from the first port 18a, whereby a droplet having a volume of five nl was prepared.

As described above, a control mechanism for a trace quantity of liquid according to the first embodiment of the present invention has a constitution wherein the first channel 21 being a thick flow channel and the second channel 22 being another thick flow channel are linked by means of the third channel 23 being a thin flow channel, so that a droplet having a volume corresponding to a capacity of the third channel is prepared due to a capillary phenomenon. Thus, a liquid can be quantitatively handled by only easy operations with the use of a simple structure.

In other words, when a capacity of the third channel, i.e., a desired volume of a droplet to be prepared is made to be, for example, a nl (nanoliter) order according to a control mechanism for a trace quantity of liquid of the first embodiment of the present invention, nl (nanoliter) ordered droplets each having a volume of a trace quantity can be quantitatively prepared by only easy operations in a simple structure.

Furthermore, since a sample liquid or the like is quantitatively handled in accordance with a control mechanism for a trace quantity of liquid of the first embodiment of the present invention, there is no need for previously filling up the first channel 21, the second channel 22, and the third channel 23 being flow channels to be used with a buffer, so that it is sufficient for introducing only the sample liquid into the flow channel, whereby the liquid can be quantitatively handled by only easier operations.

Moreover, when a control mechanism for a trace quantity of liquid according to the first embodiment of the present invention is applied to, for example, the microchip 10 as described above, nl ordered droplets each having a volume of a trace quantity can be quantitatively prepared by only easy operations with a simple structure, besides more reduction in dead volume of a sample is possible, space saving and reduction in cost can be realized in the whole unit.

More specifically, when a variety of analyses such as electrophoresis, and chromatography being required for quantitative handling of liquid is conducted, a power supply for applying voltage or the like becomes not necessary for handling quantitatively the liquid. In addition, since a unit to be used has a simple structure, a total amount of a sample required for the unit decreases, so that dead volume of the sample can be reduced, besides space saving and reduction in cost can be realized with respect to the whole unit.

Still further, a two-dimensional structure may be obtained in the above-described microchip 10 according to a control mechanism for a trace quantity of liquid in the first embodiment of the present invention. Besides, the control mechanism for a trace quantity of liquid can be fabricated easily and inexpensively in accordance with the fabrication processes shown in FIGS. 4(a) through 4(g). For this reason, the control mechanism for a trace quantity of liquid of the invention is suitable for disposable use wherein the control mechanism, which was used only once, is discarded. In addition, it becomes possible to incorporate such control mechanism into a micro device as a disposable part.

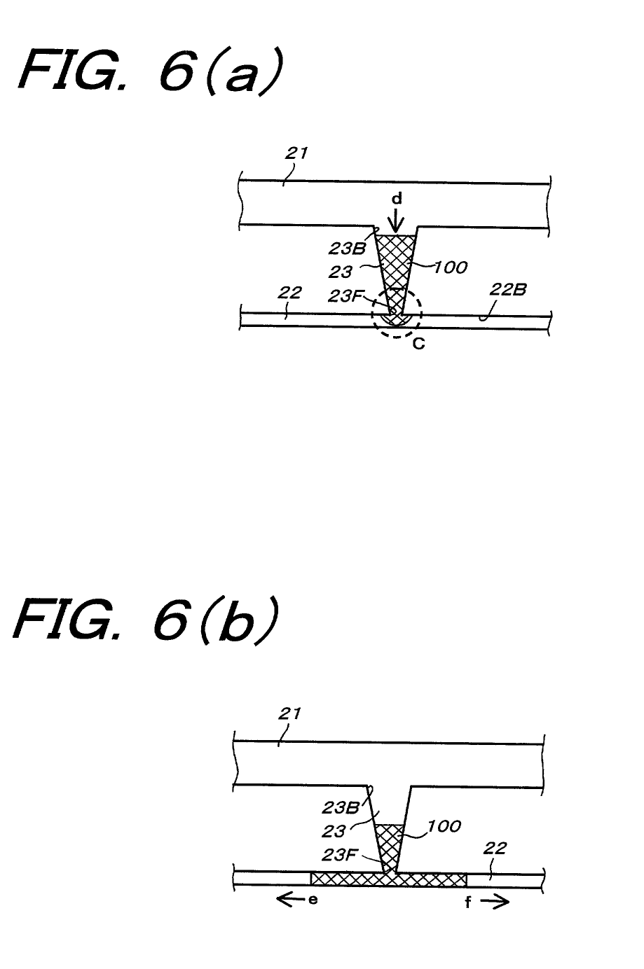

A droplet prepared in the microchip 10 involving the above-described control mechanism for a trace quantity of liquid according to the first embodiment of the invention (see FIG. 5(c)) may be discharged from the third channel 23 to the second channel 22 through the opening 23F in the third channel 23 opened on the flow channel wall 22B in the posterior side of the second channel 22 (see FIGS. 6(a) and 6(b)).

More specifically, a syringe is disposed in a predetermined port, for example, any one of them among the first port 18a, the second port 18b, the third port 18c, and the fourth port 18d, and then, an appropriate pressure difference is applied for a very short period of time to the opposite ends of a droplet, i.e., the end surfaces 100a and 100b of the liquid 100 in the third channel 23.

As a result, the liquid 100 in the third channel 23 outflows from the opening 23F (see a circled area C in FIG. 6(a)) due to the pressure difference. Since there is the following relationship:

Sectional Area S₃>Sectional Area S₄,

the liquid flowed out from the opening 23F into the second channel 22 is pulled in along the leftward direction (see an arrow e in FIG. 6(b) and the rightward direction (see an arrow f in FIG. 6(b)) due to a capillary phenomenon, so that the droplet outflows into the second channel.

In the case when the liquid 100 in the third channel 23 is flowed out into the second channel 22, it is not limited to a manner for applying a pressure with the use of a syringe as described above, but a variety of liquids may be further introduced into the first channel 21, or any of other manners is also applicable.

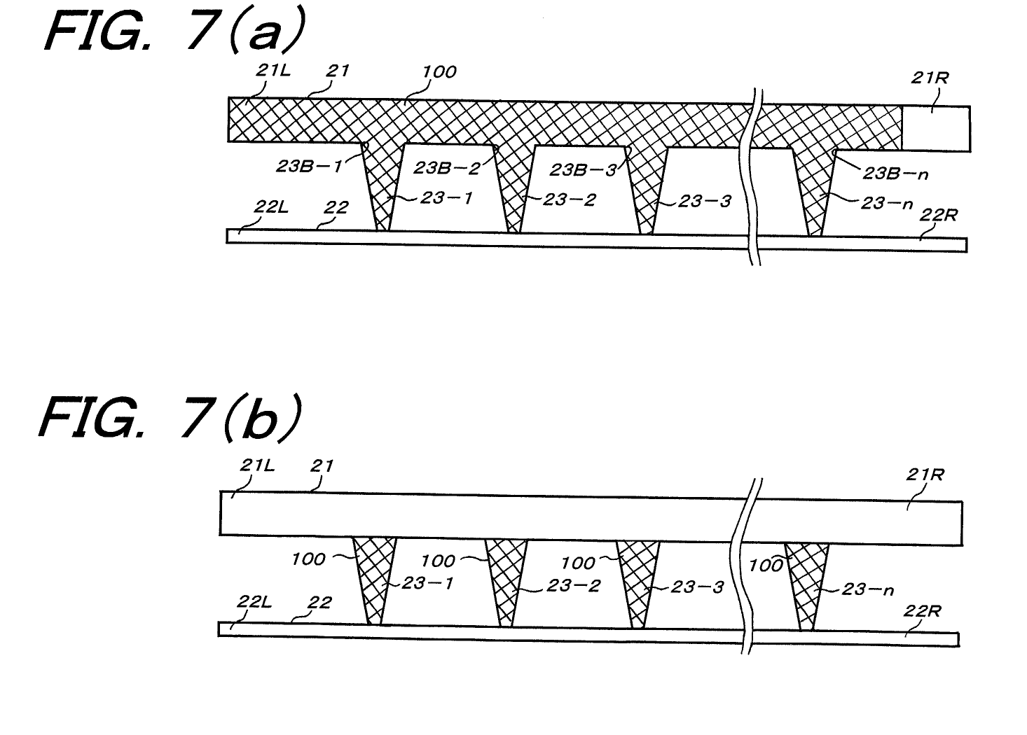

Although only one third channel 23 has been provided in the microchip 10 involving a control mechanism for a trace quantity of liquid according to the first embodiment of the present invention, the invention is not limited thereto as a matter of course, such an arrangement that the first channel 21 may be linked to the second channel 22 by means of a plurality of third channels 23 is also applicable (see FIGS. 7(a) and 7(b)).

For instance, when a plurality of third channels 23-1, 23-2, 23-3, . . . 23-n, wherein n is a positive integer and it represents the total number of the third channels 23, link a first channel 21 to a second channel 22, a liquid 100 introduced into the first channel 21 is pulled in the plural third channels 23-1 through 23-n via respective openings 23B-1, 23B-2, 23B-3, . . . 23B-n corresponding to the plurality of third channels 23-1, 23-2, 23-3, . . . 23-n (see FIG. 7(a)).

Then, when the liquid 100 remained in the first channel 21 is removed therefrom, only the liquid 100 in the form of droplets remains in the plural third channels 23-1 through 23-n, respectively, whereby the droplets each having a volume corresponding to each capacity of the third channels 23-1 through 23-n are prepared, respectively (see FIG. 7(b)).

As described above, when the plurality of third channels 23-1 through 23-n are prepared, a plurality of droplets can be quantitatively and parallelly prepared from the liquid 100 introduced into the first channel 21.

In this case, capacities of the plural third channels 23-1 through 23-n may be the same with each other or different from one another.

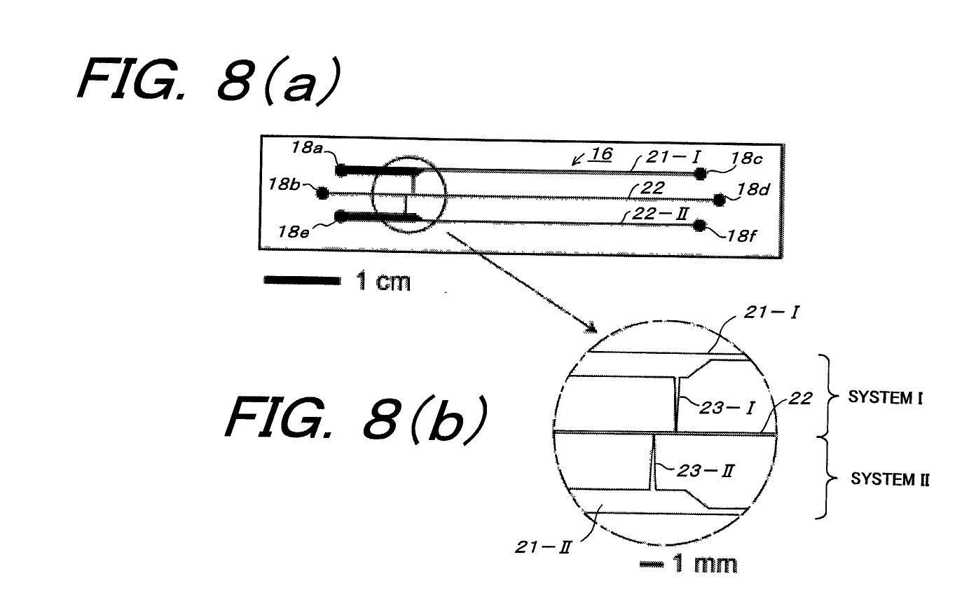

In the following, a microchip involving a control mechanism for a trace quantity of liquid according to a second embodiment of the present invention will be described by referring to FIGS. 8(a) and 8(b).

The second embodiment differs from the first embodiment in that the microchannel 16 in the first embodiment contains only one system comprising the first channel 21 and the second channel 22 as well as the third channel 23 that links the first channel 21 to the second channel 22 (see FIGS. 2(a) and 2(b)), while a microchannel 16 in the second embodiment contains two systems each comprising a first channel 21 and a second channel 22 as well as a third channel 23 that links the first channel 21 to the second channel 22 (see FIGS. 8(a) and 8(b)).

In other words, the microchannel 16 in the microchip involving a control mechanism for a trace quantity of liquid according to the second embodiment of the present invention contains two systems of a system I and a system II.

The system I is composed of a first channel 21-I, a second channel 22, and a third channel 23-I, while the system II is composed of a first channel 21-II, the second channel 22, and a third channel 23-II. Namely, the systems I and II have the second channel 22 in common with each other.

All of the first channel 21-I, the second channel 22, and the third channel 23-I constituting the above-described system I as well as the first channel 21-II, the second channel 22, and the third channel 23-II constituting the system II are dimensioned so as to satisfy the above-described numerical formulae 1 and 2, respectively.

Furthermore, it is arranged in such that all the opposite ends of the first channel 21-I, the other first channel 21-II, and the second channel 22 are positioned in any of a part of six ports 18a, 18b, 18c, 18d, 18e, and 18f, so that all the opposite ends of these channels communicates with any one of these ports, respectively.

In the second embodiment, both capacities of the third channel 23-I and the third channel 23-II are selected to be nineteen nl, respectively.

In the following, coalescent/analytical reaction of an aqueous glucose solution and a reagent for analyzing glucose will be described as an example of experimental results wherein chemical reaction is implemented by the use of a microchip in the second embodiment.

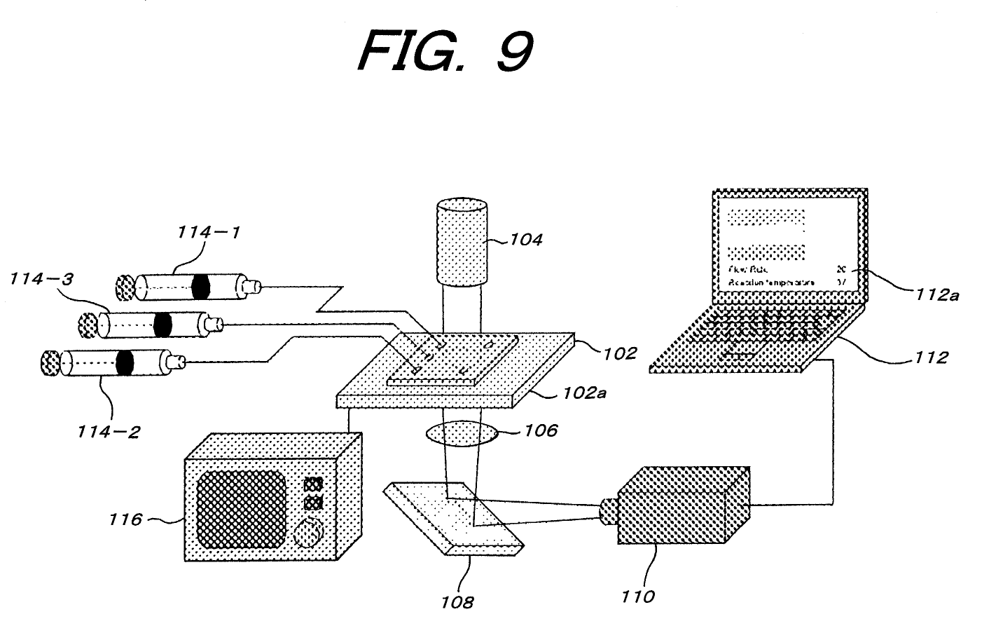

FIG. 9 is an explanatory view showing a constitution of an experimental system wherein a microchip is disposed on a stage 102. In this case, the microchip is a transparent one composed of a base plate 12 made from PDMS and a surface plate 14 made from PMMA, while the stage 102 is also transparent.

It is arranged in such that light projected from a halogen lamp 104, which is disposed so as to oppose to the surface plate 14 of the microchip, passes through the microchip and the stage 102, and the resulting light is received by a CCD camera 110 through a lens 106 and a mirror 108 placed on a side of the bottom 102a of the stage 102.

Moreover, results of light received by the CCD camera 110 are input to a personal computer 112, and they are displayed on a monitor 112a of the personal computer 112 in real time, besides they are recordable.

Samples of various reagents and the like are supplied from a syringe 114-1 connected to the port 18a communicating with a left end of the first channel 21-I and another syringe 114-2 connected to the port 18e communicating with a left end of the other first channel 21-II in the microchip.

In addition, a syringe 114-3 is also connected to the port 18b communicating with a left end of the second channel 22 in the microchip.

A temperature of the microchip is adapted to be controlled by a temperature controller 116.

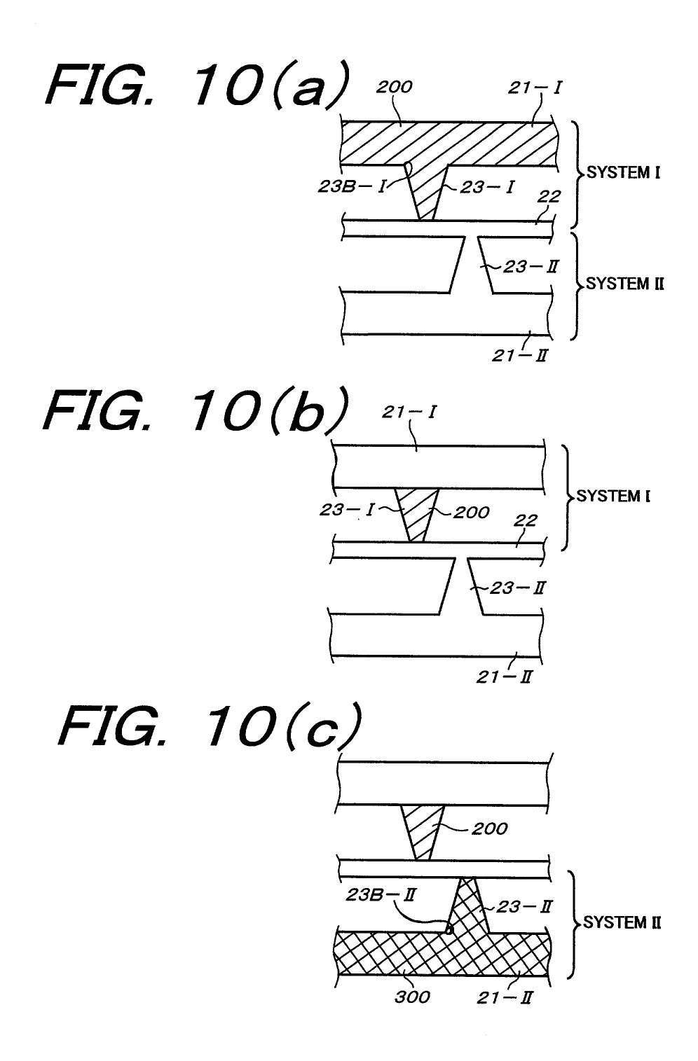

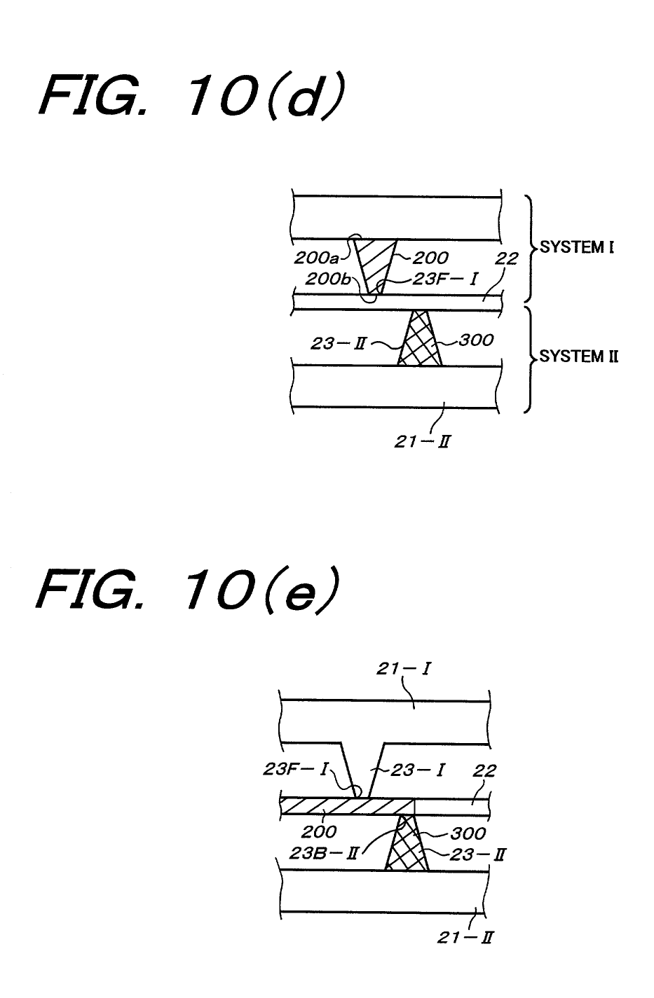

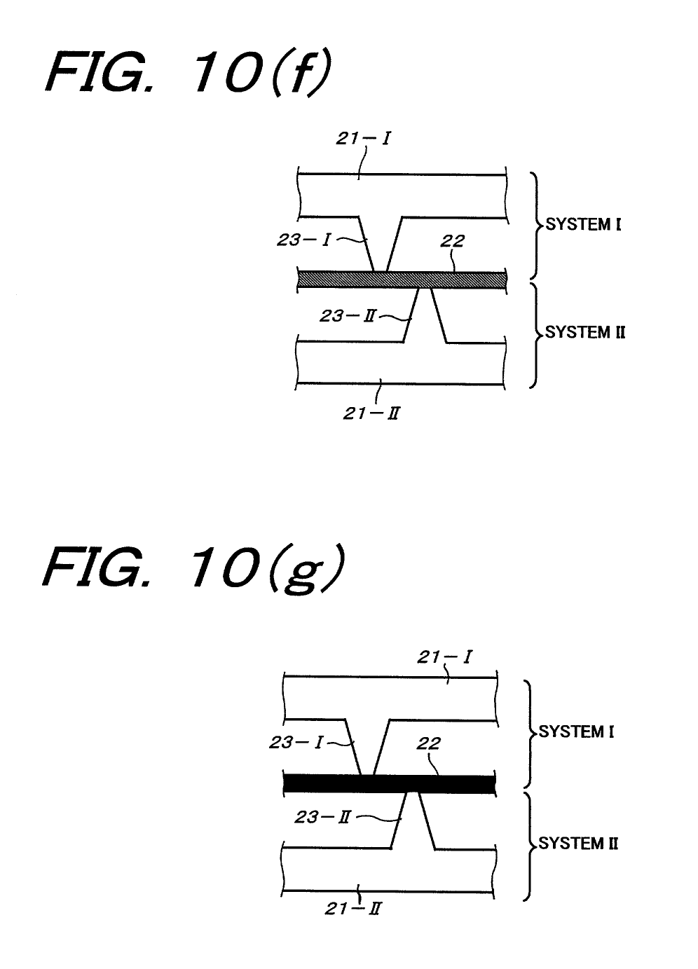

FIGS. 10(a) through 10(g) are explanatory views each showing a process for coalescent/analytical reaction of an aqueous glucose solution and a reagent for analyzing glucose with time in the microchip according to the second embodiment.

First, a droplet of a ten mM aqueous glucose solution 200 is prepared in the system I (see FIGS. 10(a) and 10(b)).

In specific operations, when one μl of the ten mM aqueous glucose solution 200 (see a region hatched in FIG. 10(a)) is dropped from the port 18a, the ten mM aqueous glucose solution 200 thus dropped is pulled inside the first channel 21-I from the left end of the first channel 21-I communicating with the port 18a due to a capillary phenomenon.

The ten mM aqueous glucose solution 200 thus introduced into the first channel 21-I is pulled in the third channel 23 from the opening 23B-I of the third channel 23-I by means of a stronger capillary attraction force (see FIG. 10(a)).

Then, the ten mM aqueous glucose solution 200 remained in the first channel 21-I is removed from the inside of the first channel 21-I. As a result, the ten mM aqueous glucose solution 200 remains in only the third channel 23-I, whereby a droplet of the ten mM aqueous glucose solution 200 having nineteen nl volume corresponding to a capacity of the third channel 23-I is prepared quantitatively (see FIG. 10(b)).

Thereafter, a droplet of a reagent 300 for analyzing glucose is prepared in the system II (see FIGS. 10(c) and 10(d)).

In a specific manner, the reagent 300 for analyzing glucose (see a region halftone dot meshed in FIG. 10(c)) is dropped from the port 18e, the reagent 300 for analyzing glucose thus dropped is pulled into the first channel 21-II from the left end of the first channel 21-II communicating with the port 18e due to a capillary phenomenon.

The reagent 300 for analyzing glucose thus introduced in the first channel 21-II is pulled into the third channel 23-II by means of a stronger capillary attraction force (see FIG. 10(c)).

Then, the reagent 300 for analyzing glucose remained in the first channel 21-II is removed therefrom. As a result, the reagent 300 for analyzing glucose remains in only the third channel 23-II, whereby a droplet of the reagent 300 for analyzing glucose having nineteen nl volume corresponding to a capacity of the third channel 23-II is prepared quantitatively (see FIG. 10(d)).

Thus, preparation of a droplet of the ten mM aqueous glucose solution 200 in the system I and preparation of a droplet of the reagent 300 for analyzing glucose in the system II are completed. Then, for example, an appropriate pressure difference is applied across an end surface 200a and the other end surface 200b of the ten mM aqueous glucose solution 200 in the third channel 23-I for a very short period of time.

As a result, the ten mM aqueous glucose solution 200 in the third channel 23-I leaves through the opening 23F-I to enter the second channel 22 (see FIG. 10(e)).

Further, when the ten mM aqueous glucose solution 200 flowed in the second channel 22 reaches the opening 23B-II of the third channel 23-II, the reagent 300 for analyzing glucose in the third channel 23-II leaves through the opening 23B-II to enter the second channel 22 (see FIG. 10(f)).

In this case, coalescence of nineteen nl of a droplet in the ten mM aqueous glucose solution 200 and nineteen nl of a droplet in the reagent 300 for analyzing glucose arises, so that the ten mM aqueous glucose solution 200 is admixed with the reagent 300 for analyzing glucose.

As a consequence, the ten mM aqueous glucose solution 200 reacts with the reagent 300 for analyzing glucose, so that red quinone coloring matter indicating a glucose amount of the ten mM aqueous glucose solution 200 is formed, whereby a mixed solution of the ten mM aqueous glucose solution 200 in the second channel 22 and the reagent 300 for analyzing glucose turns red (see a black region in FIG. 10(g)).

As described above, a microchip involving a control mechanism for a trace quantity of liquid according to the second embodiment of the present invention includes two systems of the system I composed of the first channel 21-I, the second channel 22, and the third channel 23-I linking the first and second channels 21-I and 22 to each other; and the system II composed of the other first channel 21-II, the second channel 22, and the other third channel 23-II linking these first and second channels 21-II and 22 to each other wherein the systems I and II have the second channel 22 in common. Accordingly, a plurality of different types of droplets, i.e., a droplet of the ten mM aqueous glucose solution 200 and a droplet of the reagent 300 for analyzing glucose can be quantitatively prepared, and coalescent/analytical reaction can be made upon the resulting plurality of droplets in accordance with the second embodiment.

In the second embodiment, it is also possible to handle quantitatively a liquid by only easy operations in a simple structure as in the above-described first embodiment, whereby droplets each having a nl (nanoliter) ordered volume of a trace quantity of liquid can be quantitatively prepared, so that dead volume of a sample can be reduced, and in addition, space saving and reduction in cost of the whole unit can be realized.

Hence, when a microchip involves a control mechanism for a trace quantity of liquid according to the second embodiment of the invention in a manner, for example, as described above, an analysis, a chemical reaction, or the like wherein a trace quantity of a sample is handled can be conducted. In this case, since the whole microchip is transparent, a variety of reactions of liquids introduced in the microchip can be easily observed.

Furthermore, since such type of microchip as described above is suitable for disposable use, a probability of cross contamination is low, and an inexpensive disposable system can be constituted, whereby it becomes possible to make an instant chemical reaction in an inspection in fields of research, medical care and the like, so that highly efficient operations can be realized in clinical medical care scene.

In a specific manner, when blood is used as a sample, it is possible to prepare a plurality of droplets from the sample blood, and a plurality of chemical reactions may be conducted in one microchip. Therefore, the operations are efficient, besides the microchip is disposable so that it is hygienic.

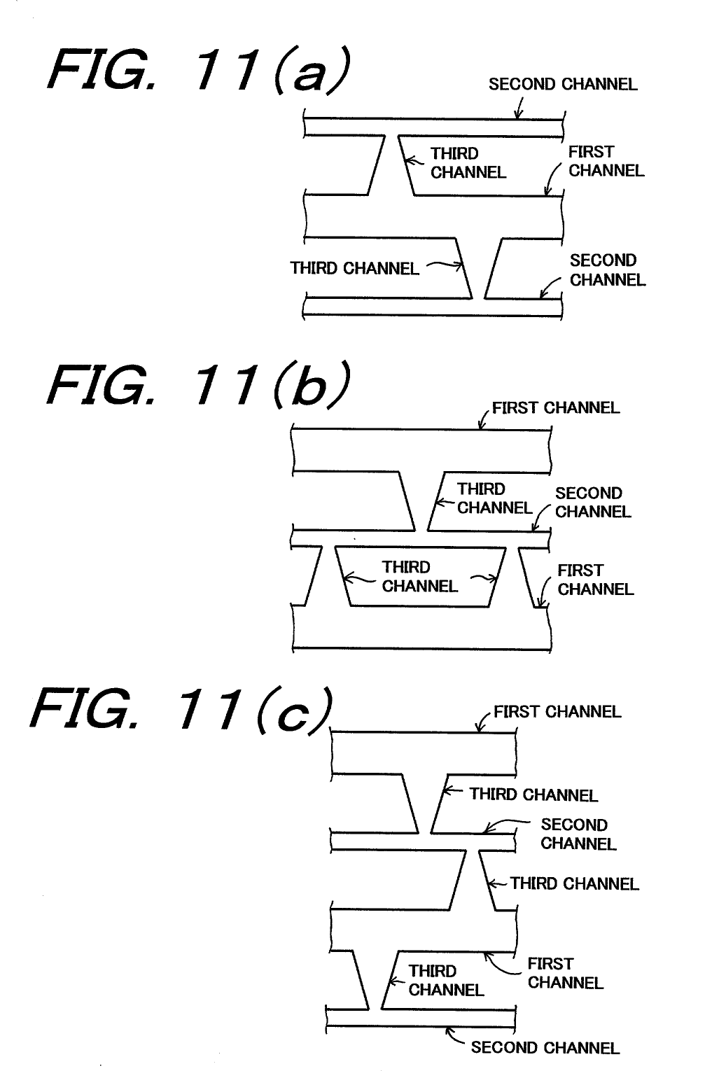

The present invention is not limited to such constitution that the two systems (system I and system II) constituting the microchannel 16 have the second channel in common, but the two systems may have the first channel in common (see FIG. 11(a)) in response to a variety of chemical reactions or types of analysis.

Moreover, a plurality of third channels may provide in also a microchip involving a control mechanism for a trace quantity of liquid according to the second embodiment of the invention as in the case of the microchip 10 involving a control mechanism for a trace quantity of liquid according to the first embodiment of the invention (see FIG. 11(b)).

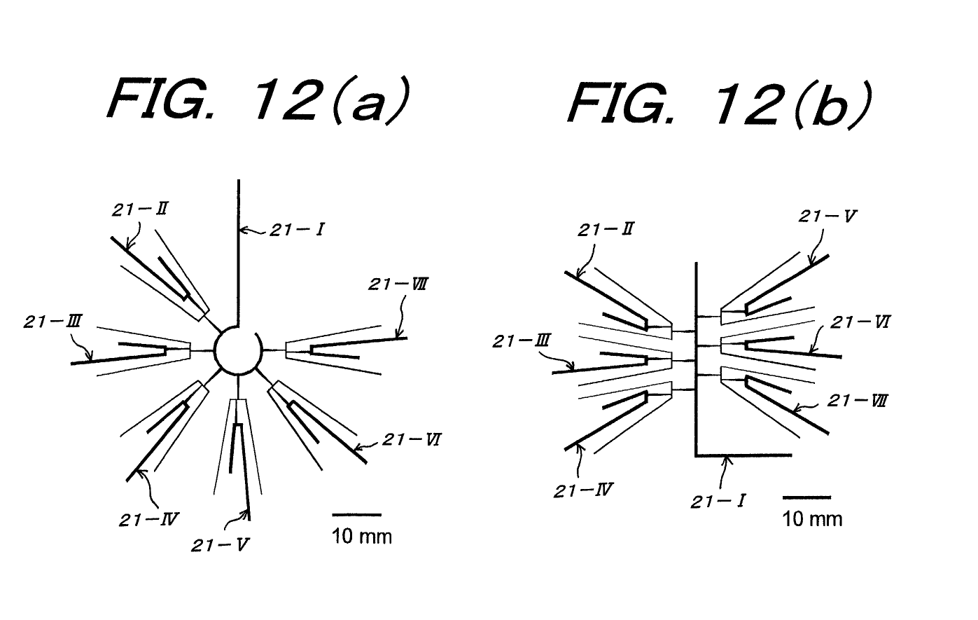

Besides, although the microchip 16 has been composed of only two systems of the system I and the system II in a microchip involving a control mechanism for a trace quantity of liquid according to the second embodiment of the invention, the present invention is not limited thereto, as a matter of course, it may be constituted in such that the microchannel 16 is composed of a plurality of the two systems of the system I and the system II (see FIG. 11(c) as well as FIGS. 12(a) and 12(b)).

For instance, FIGS. 12(a) and 12(b) are explanatory views each showing a case wherein a microchannel 16 in a microchip is composed of six each of two systems of system I and system II wherein FIGS. 12(a) and 12(b) have different layout patterns, respectively.

Under the circumstances, for example, when a sample is introduced from a first channel 21-I, the sample thus introduced is pulled in six of third channels, respectively, to prepare six sample droplets.

On the other hand, when each of different types of reagents is introduced from each of first channels 21-II, 21-III, 21-IV, 21-V, 21-VI, and 21-VII, the reagents introduced react with the six samples prepared, respectively.

According to such arrangement as described above, it becomes possible that a plurality of reagents is parallelly reacted with a single type of sample to obtain their analytical results.

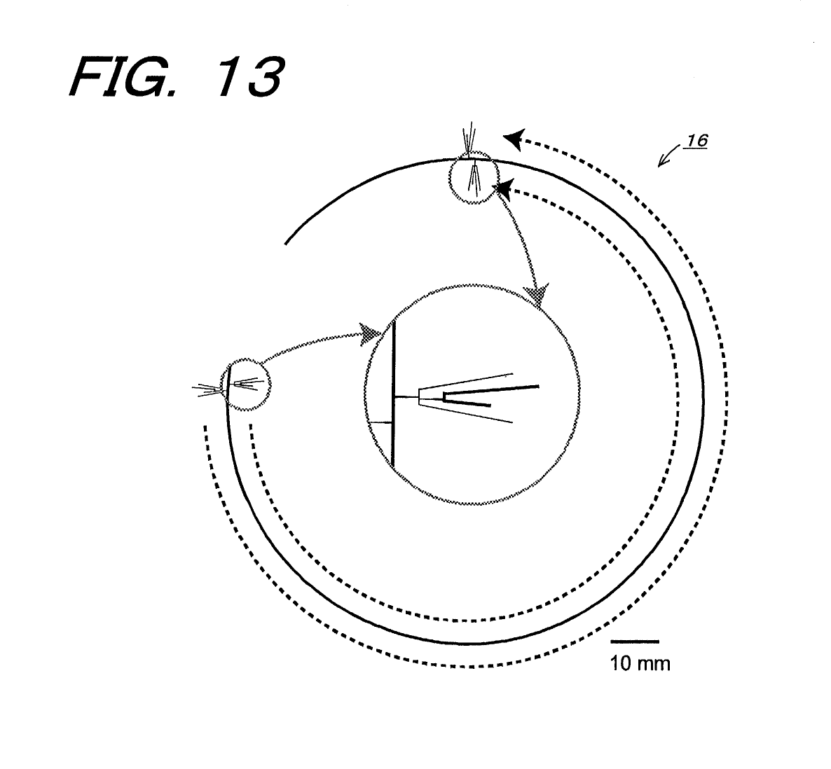

Therefore, when a microchannel 16 is composed of a number of two systems consisting of system I and system II as shown in FIG. 13, it becomes possible that much more types of reagents are reacted parallelly with a single type of sample to obtain their analytical results.

In this case, a layout pattern that is composed of a plurality of two systems consisting of system I and system II in the microchannel 16 is made to be, for example, a circular configuration as shown in FIG. 13, space saving of the whole microchannel 16 can be realized even if the plurality of the two systems consisting of the system I and the system II are utilized.

The above-described embodiments may be properly modified as described in the following paragraphs (1) through (5).

(1) In the above-described embodiments, although a variety of materials has been specifically exemplified, the invention is not limited thereto as a matter of course, but a microchip 10 may be fabricated from a material in response to various intended uses and the like. For instance, a surface plate 14 may be made from plastics, glass, or the like in place of PDMS.

Accordingly, a desirable material may be used dependent upon various intended uses and the like, and a microchip 10 may be fabricated from such material. In this case, a variety of modifications as to positions of ports to be bored and the like may be made also.

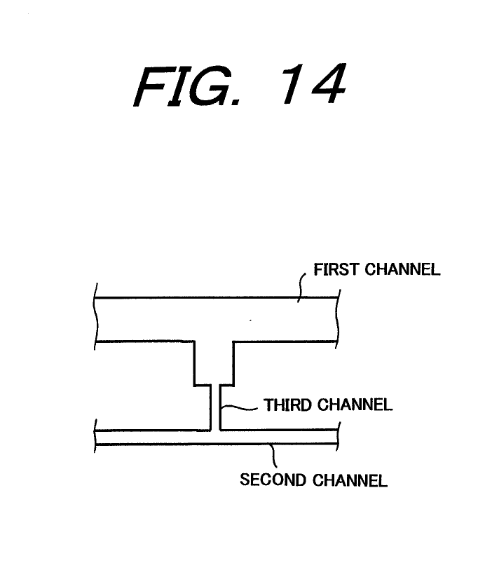

(2) While profiles of the first channel 21, the second channel 22, and the third channel 23 constituting a microchannel have been selected as shown in FIG. 3 in the above-described first and second embodiments, the invention is not limited thereto as a matter of course, but an essential point is in that a constitution of these channels satisfy the above-described numerical formula 2. Accordingly, a profile of a third channel may be modified, for example, as shown in FIG. 14.

(3) In the above-described embodiments, although addition of a pressure by the use of a syringe or syringes, or further introduction of various liquids into the first channel 21 and the like have been made in the case where a liquid in the third channel 23 is to be flowed into the second channel 22, the invention is not limited thereto.

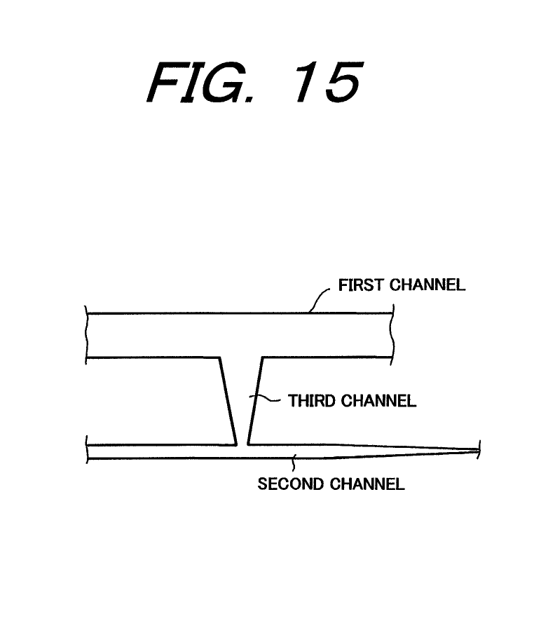

For instance, a profile of the second channel 22 may be modified to be tapered off as shown in FIG. 15, or such a structure wherein a filter paper is positioned at an end of the second channel 22 to make a liquid in the third channel 23 to be automatically transferred into the second channel is also applicable.

(4) In the above-described first and second embodiments, while a microchip has involved a control mechanism for a trace quantity of liquid according to the present invention, the invention is not limited thereto as a matter of course, but a variety of units such as an analytical instrument and the like may involve a control mechanism for a trace quantity of liquid according to the present invention.

(5) The above-described embodiments and the above-mentioned modifications made in the above paragraphs (1) through (4) may be properly combined with each other.

Since the present invention has been constituted as described above, there is such an excellent advantage that a liquid can be handled quantitatively by only easy operations in a simple structure.

Furthermore, the present invention has been constituted as described above, so that there is such an excellent advantage that dead volume of a sample can be reduced, besides space saving as well as reduction in cost of the whole unit can be realized in a variety of units wherein quantitative handling of a liquid is required.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2001-163740 filed on May 31, 2001 including specification, claims, drawing, and summary are incorporated herein by reference in its entirety.

What is claimed is:

1. A control mechanism for a trace quantity of liquid comprising:
a first flow channel and a second flow channel each extending along a predetermined direction; and
a third flow channel having a thinner thickness than that of said first flow channel and that of said second flow channel;
said third flow channel being opened on flow channel walls of said first flow channel and said second flow channel, respectively, whereby said third flow channel links said first flow channel to said second flow channel;
a liquid introduced into said first flow channel being pulled in said third flow channel by means of a capillary phenomenon through an opening of said third flow channel opened on the flow channel wall of said first flow channel, and then, said liquid remained in said first flow channel being removed to prepare a droplet having a volume corresponding to a capacity of said third flow channel.

2. A control mechanism for a trace quantity of liquid comprising:
at least two systems;
any of said systems being composed of a first flow channel as well as a second flow channel each extending along a predetermined direction, and a third flow channel having a thinner thickness than that of said first flow channel and that of said second flow channel, said third flow channel being opened on flow channel walls of said first flow channel and said second flow channel, respectively, whereby said third flow channel links said first flow channel to said second flow channel, a liquid introduced into said first flow channel being pulled in said third flow channel by means of a capillary phenomenon through an opening of said third flow channel opened on the flow channel wall of said first flow channel, and then, said liquid remained in said first flow channel being removed to prepare a droplet having a volume corresponding to a capacity of said third flow channel; and
said two systems having either of said first channel and said second channel in common.

3. A control mechanism for a trace quantity of liquid as claimed in any one of claims 1 and 2 wherein:
a condition of relationship “S₁≧S₃>S₂≧S₄” where a sectional area corresponding substantially to the opening of said third flow channel in the first flow channel is S₁, a sectional area corresponding substantially to the opening of said third flow channel in the second flow channel is S₂, a sectional area of the opening of said third flow channel is S₃, and a sectional area of the opening of said third flow channel is S₄ is satisfied.

4. A control mechanism for a trace quantity of liquid as claimed in any one of claims 1 and 2 wherein:
a plurality of said third flow channels are defined.

5. A control mechanism for a trace quantity of liquid as claimed in claim 3 wherein:
a plurality of said third flow channels are defined.

6. A control mechanism for a trace quantity of liquid as claimed in any one of claims 1 and 2 comprising further:
a means for running off a droplet prepared and having a volume corresponding to a capacity of said third flow channel therefrom to said second flow channel through the opening of said third flow channel opened on a flow channel wall of said second flow channel.

7. A control mechanism for a trace quantity of liquid as claimed in claim 3 comprising further:
a means for running off a droplet prepared and having a volume corresponding to a capacity of said third flow channel therefrom to said second flow channel through the opening of said third flow channel opened on a flow channel wall of said second flow channel.

8. A control mechanism for a trace quantity of liquid as claimed in claim 4 comprising further:
a means for running off a droplet prepared and having a volume corresponding to a capacity of said third flow channel therefrom to said second flow channel through the opening of said third flow channel opened on a flow channel wall of said second flow channel.

9. A control mechanism for a trace quantity of liquid as claimed in claim 5 comprising further:
a means for running off a droplet prepared and having a volume corresponding to a capacity of said third flow channel therefrom to said second flow channel through the opening of said third flow channel opened on a flow channel wall of said second flow channel.

10. A control mechanism for a trace quantity of liquid as claimed in any one of claims 1 and 2 wherein:
said first flow channel, said second flow channel, and said third flow channel are defined on a microchip.

11. A control mechanism for a trace quantity of liquid as claimed in claim 3 wherein:
said first flow channel, said second flow channel, and said third flow channel are defined on a microchip.

12. A control mechanism for a trace quantity of liquid as claimed in claim 4 wherein:
said first flow channel, said second flow channel, and said third flow channel are defined on a microchip.

13. A control mechanism for a trace quantity of liquid as claimed in claim 5 wherein:
said first flow channel, said second flow channel, and said third flow channel are defined on a microchip.

14. A control mechanism for a trace quantity of liquid as claimed in claim 6 wherein:
said first flow channel, said second flow channel, and said third flow channel are defined on a microchip.

15. A control mechanism for a trace quantity of liquid as claimed in claim 7 wherein:
said first flow channel, said second flow channel, and said third flow channel are defined on a microchip.

16. A control mechanism for a trace quantity of liquid as claimed in claim 8 wherein:
said first flow channel, said second flow channel, and said third flow channel are defined on a microchip.

17. A control mechanism for a trace quantity of liquid as claimed in claim 9 wherein:
said first flow channel, said second flow channel, and said third flow channel are defined on a microchip.

18. A control mechanism for a trace quantity of liquid as claimed in any one of claims 1 and 2 wherein:
flow channel walls of said first flow channel, said second flow channel, and said third flow channel are made to be hydrophilic.

19. A control mechanism for a trace quantity of liquid as claimed in claim 3 wherein:
flow channel walls of said first flow channel, said second flow channel, and said third flow channel are made to be hydrophilic.

20. A control mechanism for a trace quantity of liquid as claimed in claim 4 wherein:
flow channel walls of said first flow channel, said second flow channel, and said third flow channel are made to be hydrophilic.

21. A control mechanism for a trace quantity of liquid as claimed in claim 5 wherein:
flow channel walls of said first flow channel, said second flow channel, and said third flow channel are made to be hydrophilic.

22. A control mechanism for a trace quantity of liquid as claimed in claim 6 wherein:
flow channel walls of said first flow channel, said second flow channel, and said third flow channel are made to be hydrophilic.

23. A control mechanism for a trace quantity of liquid as claimed in claim 7 wherein:
flow channel walls of said first flow channel, said second flow channel, and said third flow channel are made to be hydrophilic.

24. A control mechanism for a trace quantity of liquid as claimed in claim 8 wherein:
flow channel walls of said first flow channel, said second flow channel, and said third flow channel are made to be hydrophilic.

25. A control mechanism for a trace quantity of liquid as claimed in claim 9 wherein:
flow channel walls of said first flow channel, said second flow channel, and said third flow channel are made to be hydrophilic.

26. A control mechanism for a trace quantity of liquid as claimed in any one of claims 1 and 2 wherein:
the capacity of said third flow channel has a nl (nanoliter) ordered dimension.

27. A control mechanism for a trace quantity of liquid as claimed in claim 3 wherein:
the capacity of said third flow channel has a nl (nanoliter) ordered dimension.

28. A control mechanism for a trace quantity of liquid as claimed in claim 4 wherein:
the capacity of said third flow channel has a nl (nanoliter) ordered dimension.

29. A control mechanism for a trace quantity of liquid as claimed in claim 5 wherein:
the capacity of said third flow channel has a nl (nanoliter) ordered dimension.

30. A control mechanism for a trace quantity of liquid as claimed in claim 6 wherein:
the capacity of said third flow channel has a nl (nanoliter) ordered dimension.

31. A control mechanism for a trace quantity of liquid as claimed in claim 7 wherein:
the capacity of said third flow channel has a nl (nanoliter) ordered dimension.

32. A control mechanism for a trace quantity of liquid as claimed in claim 8 wherein:
the capacity of said third flow channel has a nl (nanoliter) ordered dimension.

33. A control mechanism for a trace quantity of liquid as claimed in claim 9 wherein:
the capacity of said third flow channel has a nl (nanoliter) ordered dimension.
